(19) United States
(12) Patent Application Publication
(10) Pub. No.: US 2013/0315537 A1
(43) Pub. Date: Nov. 28, 2013

(54) OPTICAL MULTIPLEXING/DEMULTIPLEXING DEVICE

(71) Applicants: Tadashi MURAO, Chiyoda-ku (JP); Keita Mochizuki, Chiyoda-ku (JP); Satoshi Shirai, Chiyoda-ku (JP); Nobuyuki Yasui, Chiyoda-ku (JP)

(72) Inventors: Tadashi MURAO, Chiyoda-ku (JP); Keita Mochizuki, Chiyoda-ku (JP); Satoshi Shirai, Chiyoda-ku (JP); Nobuyuki Yasui, Chiyoda-ku (JP)

(73) Assignee: Mitsubishi Electric Corporation, Chiyoda-ku (JP)

(21) Appl. No.: 13/614,220

(22) Filed: Sep. 13, 2012

(30) Foreign Application Priority Data
May 23, 2012 (JP) 2012-118049

(51) Int. Cl. G02B 6/26

(52) U.S. Cl. 385/50

(57) ABSTRACT

An optical multiplexing/demultiplexing device comprise a plurality of propagation waveguides comprising an input waveguide capable of receiving input light and an output waveguide outputting light of a given wavelength among the wavelengths included in the input light and resonance waveguide that is an optical waveguide provided between adjoining waveguides and extends in a longitudinal direction in which both the adjoining waveguides extend, wherein the adjoining waveguides are an adjoining pair among the propagation waveguides. The distance between the resonance waveguide and each of the adjoining waveguides of the resonance waveguide and a length in the longitudinal direction of the resonance waveguide are set so as to form a transition part, wherein when a light comprising a transition wavelength set to the transition part passes through the transition part of one of the adjoining waveguides, the light of the transition wavelength component shifts to the other adjoining propagation waveguide.

### CROSS-REFERENCE TO RELATED APPLICATION

This application claims the benefit of Japanese Patent Application No. 2012-118049, filed on May 23, 2012, the entire disclosure of which is incorporated by reference herein.

### FIELD

This application relates to an optical multiplexing/demultiplexing device.

### BACKGROUND

Optical multiplexing/demultiplexing devices for introducing light of a plurality of wavelengths to the optical path are known. For example, N. J. Florous et al. (Optics Express, Vol. 14, pp. 4861-4872, May 2006) discloses an optical multiplexing/demultiplexing device consisting of a multicore PBGF (photonic band gap fiber) and utilizing the resonant tunneling effect.

A problem of the prior art optical multiplexing/demultiplexing device is significant optical loss. For example, the optical multiplexing/demultiplexing device disclosed by Florous et al. utilizes an optical fiber and therefore optical loss occurs at the coupling part to a planar optical system using optical waveguides. In addition, the optical multiplexing/demultiplexing device disclosed by Florous et al. utilizes a fixed length of fiber for optical coupling. The cycle of coupling to the output waveguide must be equal for all wavelengths to be multiplexed/demultiplexed. For that reason, the fiber length is increased and so is the device size.

The present invention is invented to solve the above problem and an exemplary object of the present invention to provide a low loss and reduced-in-size optical multiplexing/demultiplexing device.

### SUMMARY

In order to achieve the above object, the optical multiplexing/demultiplexing device of the present invention comprises a plurality of propagation waveguides that is optical waveguides propagating light and comprising an input waveguide capable of receiving input light and an output waveguide outputting light of a given wavelength among the wavelengths included in the input light; and

a resonance waveguide that is an optical waveguide provided between adjoining waveguides and extends in a longitudinal direction in which both the adjoining waveguides extend, wherein the adjoining waveguides are an adjoining pair among the plurality of the propagation waveguides,

wherein the distance between the resonance waveguide and each of the adjoining waveguides of the resonance waveguide and a length in the longitudinal direction of the resonance waveguide are set so as to form a transition part, wherein when a light comprising a transition wavelength set to the transition part passes through the transition part of one of the adjoining waveguides, the light of the transition wavelength component shifts to the other adjoining propagation waveguide.

The present invention can provide a low loss and reduced-in-size optical multiplexing/demultiplexing device.

### BRIEF DESCRIPTION OF THE DRAWINGS

A more complete understanding of this application can be obtained when the following detailed description is considered in conjunction with the following drawings, in which:

FIG. 1 is a block diagram showing the optical transfer system according to Embodiment 1 of the present invention;

FIG. 2 is a block diagram showing the structure of the optical multiplexing/demultiplexing device according to Embodiment 1;

FIG. 3A is a chart showing a wavelength spectrum of light passing through a propagation waveguide according to Embodiment 1;

FIG. 3B is a chart showing a wavelength spectrum of light passing through a propagation waveguide according to Embodiment 1;

FIG. 3C is a chart showing a wavelength spectrum of light passing through a propagation waveguide according to Embodiment 1;

FIG. 3D is a chart showing a wavelength spectrum of light passing through a propagation waveguide according to Embodiment 1;

FIG. 4 is a graphical representation showing dispersion curves according to Embodiment 1;

FIG. 5 is a block diagram showing the structure of the optical multiplexing/demultiplexing device according to Embodiment 2 of the present invention;

FIG. 6 is a block diagram showing the structure of the optical multiplexing/demultiplexing device according to Embodiment 3 of the present invention;

FIG. 7 is a graphical representation showing dispersion curves according to Embodiment 3;

FIG. 8A is a chart showing a wavelength spectrum of light passing through a propagation waveguide according to Embodiment 3;

FIG. 8B is a chart showing a wavelength spectrum of light passing through a propagation waveguide according to Embodiment 3;

FIG. 9 is a block diagram showing the structure of the optical multiplexing/demultiplexing device according to Embodiment 4 of the present invention;

FIG. 10A is a chart showing a wavelength spectrum of light passing through a propagation waveguide according to Embodiment 4; and

FIG. 10B is a chart showing a wavelength spectrum of light passing through a propagation waveguide according to Embodiment 4.

### DETAILED DESCRIPTION

The optical transfer system according to embodiments of the present invention will be described hereafter with reference to the drawings. In the figures, the same or the equivalent components are referred to by the same reference numbers.

### Embodiment 1

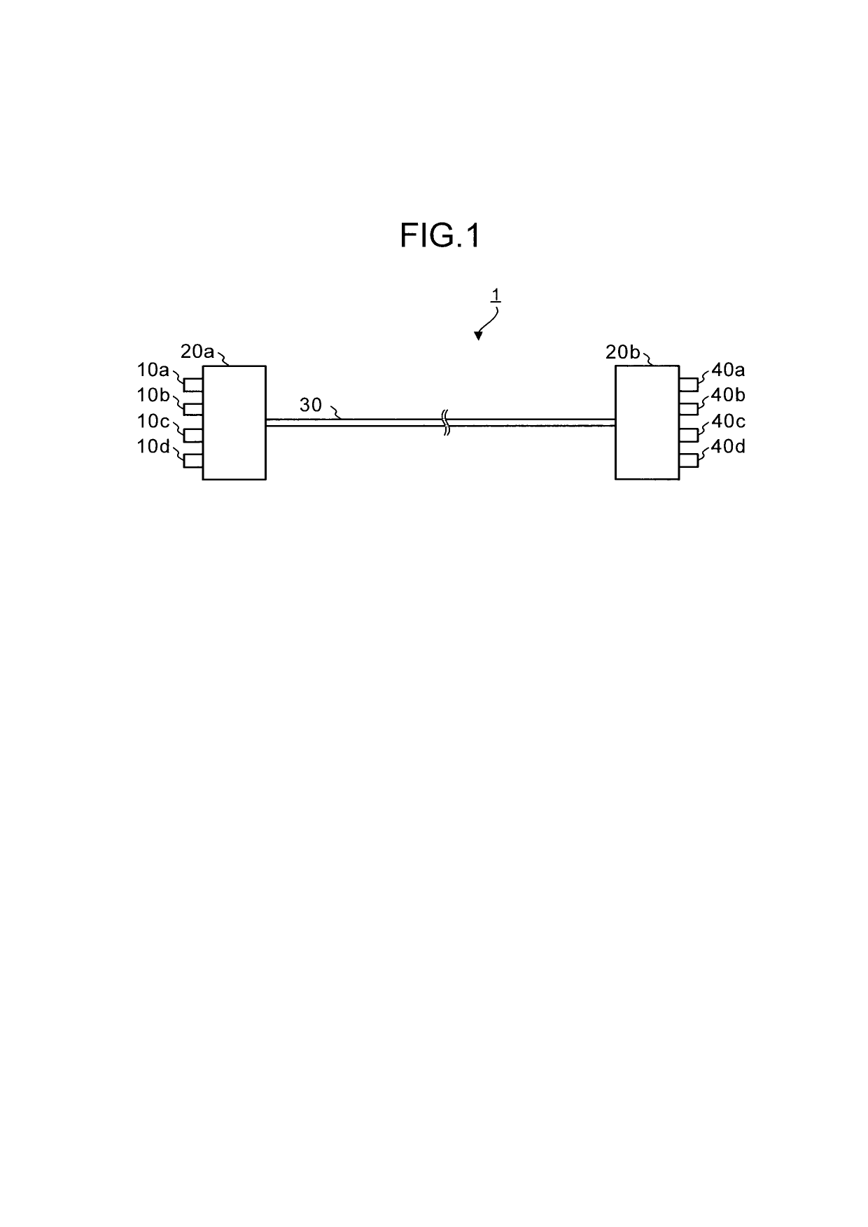

An optical transfer system 1 according to this embodiment includes, as shown in FIG. 1, a plurality of light emitters 10 (light emitters 10a to 10d), an optical multiplexer 20a, an optical cable 30, an optical demultiplexer 20b, and a plurality of light receptors (light receptors 40a to 40d).

The plurality of the light emitters (light emitters 10a to 10d) comprises laser diode elements emitting light (a beam of light) of different wavelengths from each other. The light emitter 10 emits light having a wavelength spectrum set to the emitter 10 and carrying superimposed information to be transferred.

The optical multiplexing/demultiplexing devices 20 (optical multiplexer 20a and optical demultiplexer 20b) have a side that contacts the outside of the optical transfer system 1 (the outer side) and a side that contacts with inside the optical transfer system 1 (the inner side). The optical multiplexing/demultiplexing devices 20 have multiple input/output terminals enabling optical input/output on the outer side (the outer terminals), and an input/output terminal on the inner side (the inner terminal). The specific structure of the optical multiplexing/demultiplexing devices 20 (optical multiplexer 20a and optical demultiplexer 20b) will be described later.

The optical multiplexer 20a receives beams of light (input light) from the plurality of light emitters 10 at outer terminals of the optical multiplexer 20a and outputs a output light (a beam of the propagation light comprising a plurality of transition wavelengths set to the system) to the optical cable 30 connected to its inner terminal. The optical demultiplexer 20b receives the propagation light from the optical cable 30 connected to its inner terminal and outputs output light comprising a particular wavelength to the light receptor 40a to 40d connected to its outer terminals.

The optical cable 30 comprises a clad optical fiber, which is connected to the inner terminal of the optical multiplexer 20a at one end and to the inner terminal of the optical demultiplexer 20b at the other end. Having such a physical structure, the optical cable 30 propagates the “propagation light” output from the optical multiplexer 20a to the optical demultiplexer 20b.

The plurality of the light receptors 40 (light receptor 40a to 40d) comprises photoelectric elements and is connected to the outer terminals of the optical demultiplexer 20b, respectively. Having such a physical structure, the light receptor 40 receives the light output from the optical demultiplexer 20b.

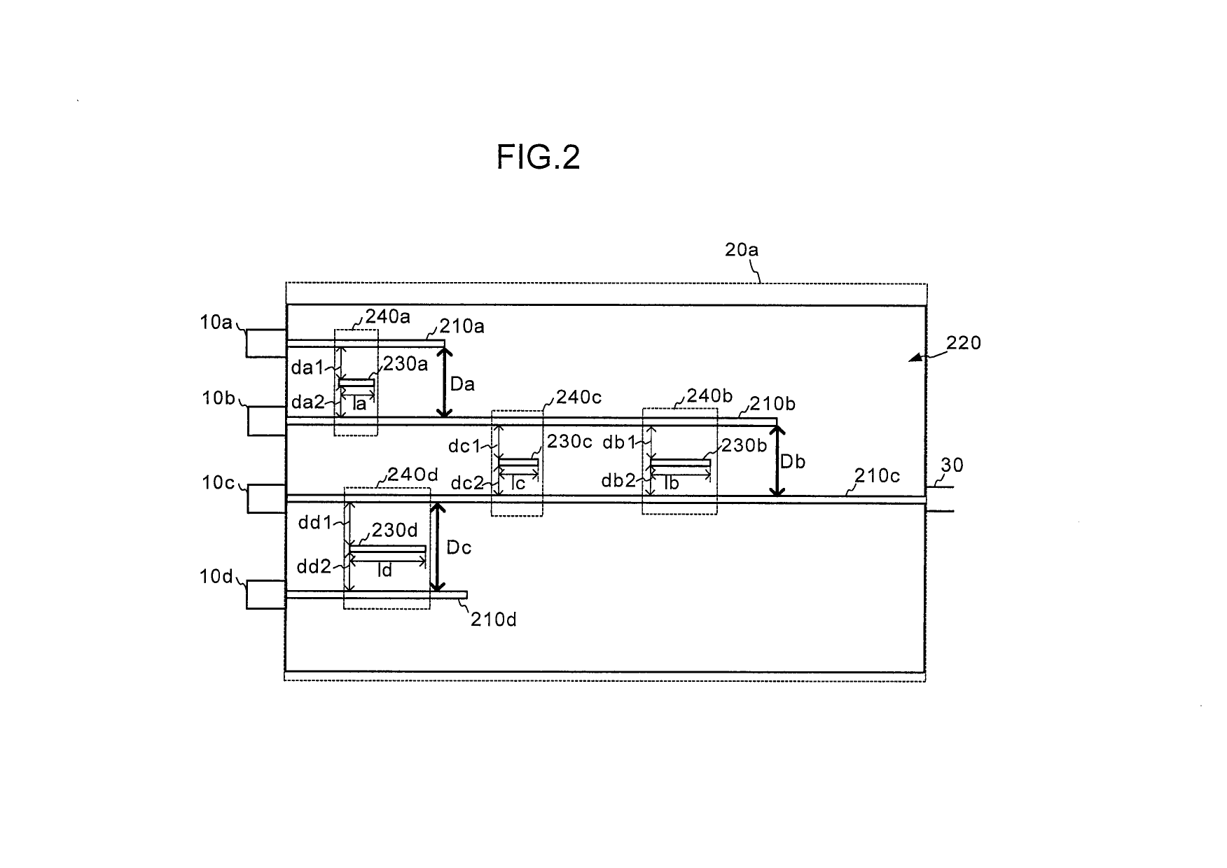

The structure of the optical multiplexer 20a will be described hereafter with reference to FIG. 2. FIG. 2 is a top view of the optical multiplexer 20a that is a waveguide type resonant tunneling optical multiplexing/demultiplexing device.

In the optical multiplexer 20a, a plurality of propagation waveguides 210 (propagation waveguides 210a to 120d) and a plurality of resonance waveguides 230 (resonance waveguides 230a to 230d) are formed in a planar area within a clad 220.

In FIG. 2, the left side of the optical multiplexer 20a (the side where the light emitters 10 are connected) is referred to as the outer side, and the side where the optical cable 30 is connected is referred to as the inner side. In the following explanation, the part of the optical transfer system 1 where the optical cable is provided is referred to as the inside and the part thereof where the light emitter or light receptor are connected is referred to as the outside.

The clad is composed of, for example, silica glass.

The propagation waveguides (propagation waveguides 210a to 210d and resonance waveguides 230a to 230d) have a core made of silica glass, for example, having a refractive index of 1.45 and covered with the clad. The relative refractive index difference between the clad and core for light of a wavelength λ is presented by a symbol Δ. The clad and core can be manufactured using an existing method of creating a planar optical wave circuit.

The propagation waveguides 210a to 210d extend nearly in parallel in the longitudinal direction (the horizontal direction in FIG. 2). The propagation waveguides 210a to 210d have the light emitters 10a to 10d connected at the end on the outer side (the outer terminals), respectively.

Each of the other end of the propagation waveguides 210a, 210b, and 210d (input waveguides) terminates within the clad. Here, the other end of the input waveguides can be open to the inner side.

The propagation waveguide 210c is connected to the optical cable 30 inside and outputs the beam of light, in which the components of light from the emitters 10a to 10d are multiplexed, to the optical cable 30.

As described above, since the propagation waveguides 210a, 210b, and 210d of the optical multiplexer 20a receive light from the light emitter, they can be termed input waveguides. Furthermore, since the propagation waveguide 210c receives light from the light emitter 10c and outputs light to the optical cable 30, it can be termed an output waveguide or an input/output waveguide.

The resonance waveguide 230a is provided between the propagation waveguides 210a and 210b. The resonance waveguide 230a forms a transition part 240a in which light of a specific wavelength (transition wavelength) shifts between adjoining propagation waveguides (adjoining waveguides or adjoining pair among the plurality of the propagation waveguides). In the transition part 240a, light forms a state called a coupling mode.

For realizing a coupling mode, the transition part 240a is designed so that the adjoining waveguides (propagation waveguides 210a and 210b) have an equally effective refractive index for a set transition wavelength. The resonance waveguide 230a has a core size and refractive index determined for equalizing the effective refractive index for a set transition wavelength to the propagation waveguides 210a and 210b.

The core shape and length (la in FIG. 2) of the resonance waveguide 230a can be determined by simulation in a finite element approach using wave equations based on the Maxwell's equations. Specific simulation schemes include the planar wave expansion method and time domain difference method.

The length (la) of the resonance waveguide 230a is equal to the complete coupling length (lcp) determined by the effective refractive index of the transition part 240a for light of λ1.

Here, the complete coupling length (lcp) means the length of a waveguide required for the power of light of a transition wavelength λ1 being propagated through the propagation waveguide 210a or 210b constituting the transition part 240a to be completely shifted to the other propagation waveguide.

When there is one resonance waveguide as in this embodiment, a total of three coupling modes (two even modes and one odd mode), are established for a wavelength λ1. It is assumed that the effective refractive index in one of the even modes is “ne” and the effective refractive index in the odd mode is “no”.

The values of “ne” and “no” are determined by the shape, size, and refractive index of the propagation waveguides 210a and 210b and resonance waveguide 230a and the values of da1 and da2. Here, da1 is the distances between the resonance waveguide 230a and the propagation waveguide 210a, and da2 is the distances between the resonance waveguide 230a and the propagation waveguide 210b.

Here, the complete coupling length lcp can be presented by the formula (1) below:

lcp=λ1/(2|ne−no|) (1)

As the distances da1 and da2 are increased, the mode coupling level is diminished and the value of |ne−no| is decreased. Consequently, the length la for forming the transition part 240a is increased. Thus, the longitudinal dimension of the optical multiplexer 20a can be reduced by reducing the distances da1 and da2.

Furthermore, it is assumed that the distance between the propagation waveguides 210a and 210b is Da. A total of two coupling modes (one even mode and one odd mode), are established between the two waveguides (the propagation waveguides 210a and 210b). Then, depending on the distance Da and the lengths of the propagation waveguides 210a and 210b, light of extra wavelength components may shift somewhere other than the transition part.

The complete coupling length lcp of the coupling mode between the propagation waveguides 210a and 210b is determined by the formula (1) in which “ne” is the effective refractive index in one even mode and “no” is the effective refractive index in one odd mode. Such extra shift causes deterioration in the extinction ratio of the optical multiplexer 20a. Therefore, the distance Da and the lengths of the propagation waveguides 210a and 210b of the optical multiplexer 20a are designed so that the complete coupling length (lcp) for the wavelengths entered by the light emitters 10a and 10b is sufficiently large with respect to the length over which the propagation waveguides extend in parallel. Here, the length over which the propagation waveguides 210a and 210b extend in parallel is equal to or more than ⅕ of the complete coupling length determined for the wavelength of the highest mode coupling level in the light emitted by the light emitters 10a and 10b.

Similarly, the resonance waveguide 230b is provided between the propagation waveguides 210b and 210c to form a transition part 240b. The transition part 240b shifts light of a wavelength λ2. The resonance waveguide 230c is further provided between the propagation waveguides 210b and 210c to form a transition part 240c. The transition part 240c shifts light of a wavelength λ1. Furthermore, the resonance waveguide 230d is provided between the propagation waveguides 210d and 210c to form a transition part 240d. The transition part 240d shifts light of a wavelength λ4.

The resonance waveguide 230b has a core size and refractive index set for equalizing the effective refractive index to propagation waveguides 210b and 210c for the wavelength λ2 to be shifted in the transition part 240b. Similarly, the length lb is set to a numeric value determined by the formula (1) for the effective refractive index in the coupling mode of the transition part 240b that is obtained by simulation in a finite element approach based on the shape, dimension, refractive index of the propagation waveguides 210b and 210c and resonance waveguide 230b for the wavelength λ2, and db1 and db2.

The same applies to the transition parts 240c and 240d.

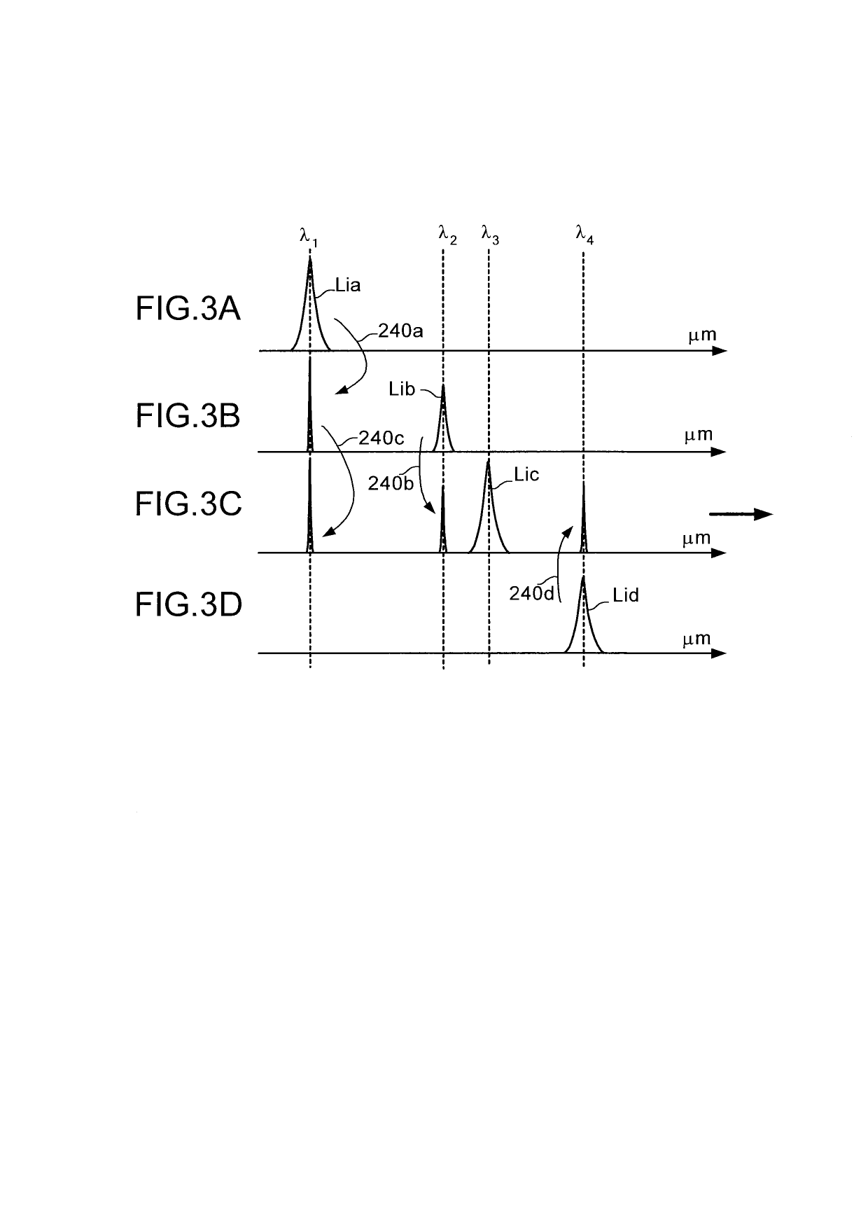

An exemplary process of the optical multiplexer 20a multiplexing input light and outputting it will be described hereafter with reference to FIGS. 3A to 3D. FIGS. 3A to 3D show wavelength spectra of light passing through the propagation waveguides. The wavelength of light is plotted as abscissa and the intensity of light of a corresponding wavelength is plotted as ordinate.

As the light emitter 10a emits input light Lia including a wavelength λ1, light of a wavelength spectrum shown in FIG. 3A is introduced in the propagation waveguide 210a. As this light reaches the transition part 240a of which the transition wavelength is λ1, the component λ1 shifts to the propagation waveguide 210b. Input light Lib emitted by the light emitter 10b and including a wavelength λ2 is also introduced into the propagation waveguide 210b. Consequently, the light shown in FIG. 3B occurs in the propagation waveguide 210b.

As the light in FIG. 3B reaches the transition part 240c of which the transition wavelength is λ1, the component λ1 shifts to the propagation waveguide 210c. Then, as the light that did not shift there reaches the transition part 240b of which the transition wavelength is λ2 through the propagation waveguide 210b, the component λ2 shifts to the propagation waveguide 210c.

Input light Lid emitted by the light emitter 10d and including a wavelength λ4 is also introduced into the propagation waveguide 210d (FIG. 3D). Then, the component λ4 shifts to the propagation waveguide 210c via the transition part 240d of which the transition wavelength is λ4.

Input light Lic emitted by the light emitter 10c and including a wavelength component λ3 is also introduced into the propagation waveguide 210c. Consequently, light of the wavelength spectrum shown in FIG. 3C is introduced in the propagation waveguide 210c. This light is output from the outer end of the propagation waveguide 210c to the optical cable 30.

As described above, the optical multiplexer 20a has input terminals receiving light of preset wavelength to be included in output light (to which the light emitter 10 emitting light of those wavelength is connected). Then, the optical path from the set input terminal to the output terminal is established by the propagation waveguides and transition parts. For forming the optical path, the transition parts corresponding to the wavelength are formed in the propagation waveguides between the input waveguide and the output waveguide. For example, in the examples of FIGS. 3A, the light emitter 10a emitting light of a wavelength λ1 is connected to the input terminal of the propagation waveguide 210a (the input waveguide for the wavelength λ1). Then, the optical path is established from the input terminal of the propagation waveguide 210a to the output terminal of the propagation waveguide 210c via the transition part 240a, propagation waveguide 210b, and transition part 240c.

In other words, each propagation waveguide includes both an input portion to introduce light of a wavelength of which the optical path includes the propagation waveguide (the input terminal or the transition part closer to the input waveguide) and an output portion to deliver light introduced into the waveguide to the output side (the transition part closer to the output waveguide or the output terminal). For example, the propagation waveguide 210b has the transition part 240a as the input portion and the transition part 240c as the output portion for λ1. Furthermore, the propagation waveguide 210b has the input terminal connected to the light emitter 10b as the input portion and the transition part 240b as the output portion for λ2. The output portion is situated on the inner side of the input portion in the longitudinal direction along the propagation waveguide. Having the above structure, the optical multiplexing/demultiplexing device 20 receives light including a wavelength component at the corresponding input terminal of the optical path of the wavelength, and outputs output light including the wavelength component to the output terminal.

An exemplary design of the transition part will be described hereafter, in which the transition wavelength of the transition part 230a is λ1=1.304 μm.

First, the propagation waveguides 210a and 210b constituting the transition part 230a are made substantially equal in core dimensions (height and width) and light refractive index. Here, substantially equal means that the propagation waveguides are equal in the dimensions and material except for manufacturing errors.

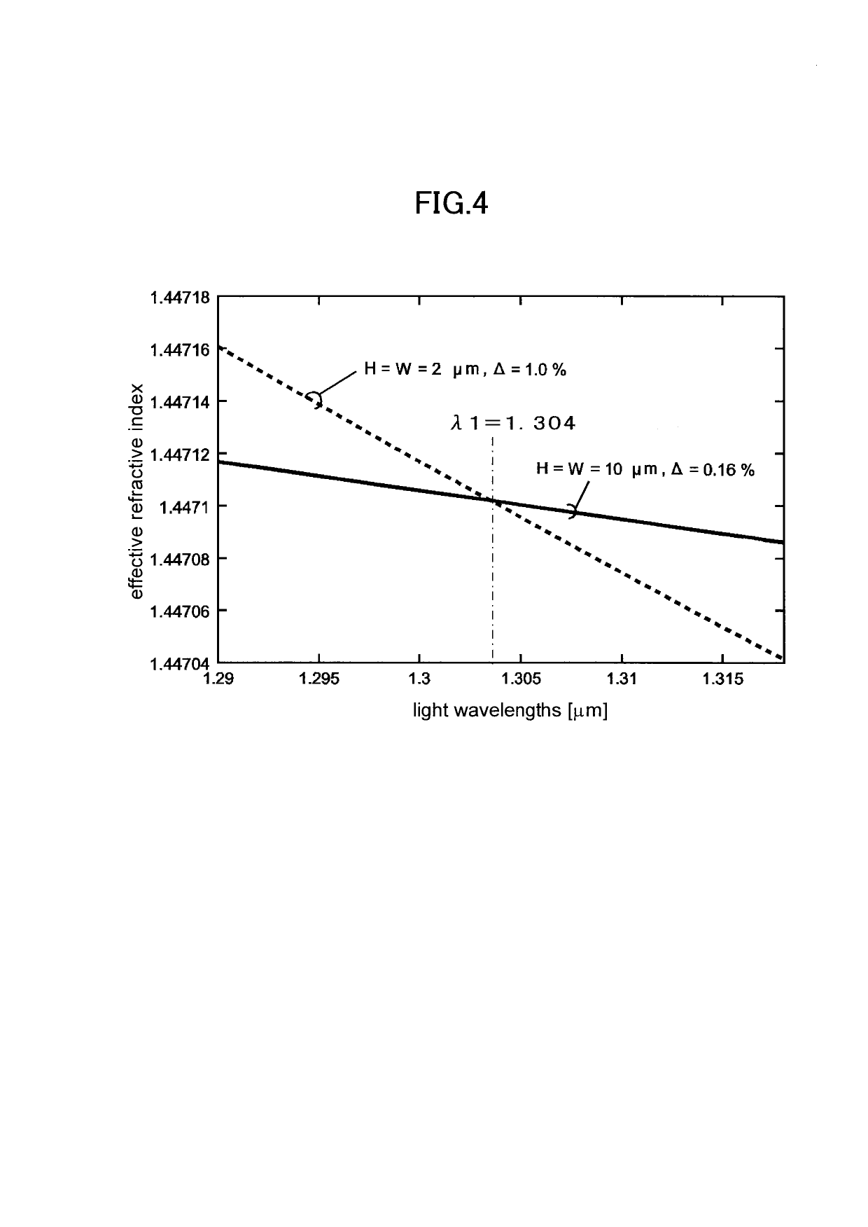

Furthermore, it is assumed that the propagation waveguides 210a and 210b have W=H=10 μm and Δ=0.16% in which W and H are the horizontal length and vertical length of a waveguide core, and Δ is the relative refractive index difference between the core and clad. On the other hand, it is assumed that the resonance waveguide 240a has W=H=2 μm and Δ=1%. In such a case, the propagation waveguides and resonance waveguide yield, for example, the dispersion curves shown in FIG. 4. The dispersion curves in FIG. 4 are obtained by graphically representing light wavelengths (abscissa) and the corresponding waveguide effective refractive indices (ordinate).

With the dispersion curves in FIG. 4, the propagation waveguide dispersion curve presented by the solid line and the resonance waveguide dispersion curve presented by the dotted line intersect with each other at 1.304 μm (the dash-dot line). Here, the length (la) of the resonance waveguide 230a is set to the complete coupling length (lcp) for λ1 obtained by the formula (1), whereby the transition part 240a has a transition wavelength λ1(1.304 μm). In other words, the light forms a coupling mode and light of a wavelength λ1 can be shifted by the resonant tunneling effect.

The optical demultiplexer 20b has the same structure as the optical multiplexer 20a shown in FIG. 2. However, the light receptors 40a to 40d are connected to the outer terminals of the propagation waveguides 210a to 210d, respectively.

In the optical demultiplexer 20b, the propagation light shown in FIG. 3C is propagated from the optical cable 30 to the propagation waveguide 210c. Then, light of a wavelength Xl and light of a wavelength λ2 are shifted to the propagation waveguide 210b in the transition part 240c and in the transition part 240b, respectively. Then, of the light shifted to the propagation waveguide 210b, the component Xl is shifted to the propagation waveguide 210a in the transition part 240a. Similarly, light of a component λ4 is propagated to the propagation waveguide 210d in the transition part 240d.

In this way, lights of the components λ1 to λ4 in the input light entered from the optical cable 30 are demultiplexed and reach the light receptors 40a to 40d.

As described above, since the propagation waveguides 210a, 210b, and 210d of the optical demultiplexer 20b output light to the light receptors 40a, 40b, and 40d, they can be termed the output waveguides. On the other hand, since the propagation waveguide 210c receives light from the optical cable 30 and outputs light to the light receptor 40c, it can be termed the input waveguide or the input/output waveguide.

As described above, the optical multiplexer 20a of this embodiment can receive a plurality of input lights and output a plurality of lights of desired wavelength components. Furthermore, the optical demultiplexer 20b of this embodiment can demultiplex input light including a plurality of wavelength components and output demultiplexed lights of desired wavelength components. In other words, optical multiplexing and demultiplexing is available.

In addition, as shown in FIG. 2, in the optical multiplexing/demultiplexing device 20, multiple propagation waveguides 210 are arranged in a multistage manner in the direction (circumferential direction) perpendicular to the direction in which light is propagated (the longitudinal direction). Then, the resonance waveguides are provided in parallel between the multistage propagation waveguides 210 to form transition parts. Therefore, the optical multiplexing/demultiplexing device can be reduced in the longitudinal length necessary for multiplexing/demultiplexing light of a desired number of wavelength components. In other words, this embodiment can provide a reduced-in-size optical multiplexing/demultiplexing device.

For example, when a structure with a directional coupler or Mach-Zehnder element is used, waveguide bends have to be used to make multiple waveguides closer to each other, which will increase the size. This embodiment will solve this problem.

Furthermore, this embodiment utilizes a resonance waveguide extending in parallel to the propagation waveguides to realize a transition part, thereby realizing a compact structure in the circumferential direction compared with, for example, where a ring resonator is used.

Furthermore, since the optical multiplexing/demultiplexing device of this embodiment is composed of a planar optical system, it can easily be connected to another waveguide constituting a planar optical system. Thus, a higher degree of freedom of design is allowed.

Furthermore, if the input light Lia emitted by the light emitter 10a includes a wavelength λ1 (1.304 μm), it is possible to shift the desired wavelength λ1 in the transition parts (the transition parts 240a and 240c) so as to include it in the output light. On the other hand, the wavelength components other than λ1 do not shift; a desired wavelength can selectively be shifted in the transition parts. For example, if the light emitter 10b emits light Lib of a wavelength λ2 of, for example, 1.300 μm, which is sufficiently different from λ1, no shift from the propagation waveguide 210b to 210a occurs. Therefore, the component λ2 can be delivered to a desired output waveguide (the propagation waveguide 210c).

Furthermore, with the resonance waveguide 230a having a length equal to the complete coupling length, the input light can efficiently be output. For example, there is no resonance waveguide 230a on the path of propagation light that is completely shifted to a post-transition waveguide (the propagation waveguide 210b) through the propagation waveguide 210b from the transition part 240a. Therefore, light of a wavelength component λ1 does not return to the pre-transition propagation waveguide 210a again. Thus, light of a desired wavelength component λ1 is efficiently output.

Furthermore, the structure of this embodiment simply requires provision of resonance waveguides; there is no need of bending the propagation waveguides to make them closer to each other for a higher degree of optical coupling. Thus, a highly efficient optical multiplexing/demultiplexing device with low loss having fewer bends can be provided.

Furthermore, an optical multiplexing/demultiplexing device using a reflective grating structure requires a microstructural grating part. In such a case, the verticality of the waveguide walls in the grating part largely affects crosstalk and/or loss characteristic, lowering the manufacturing tolerance. Furthermore, an optical multiplexing/demultiplexing device having a multimode interference waveguide structure has a problem of inevitable principled loss.

The optical multiplexing/demultiplexing device of this embodiment can provide an optical multiplexing/demultiplexing device having higher optical efficiency than the above structures.

### Embodiment 2

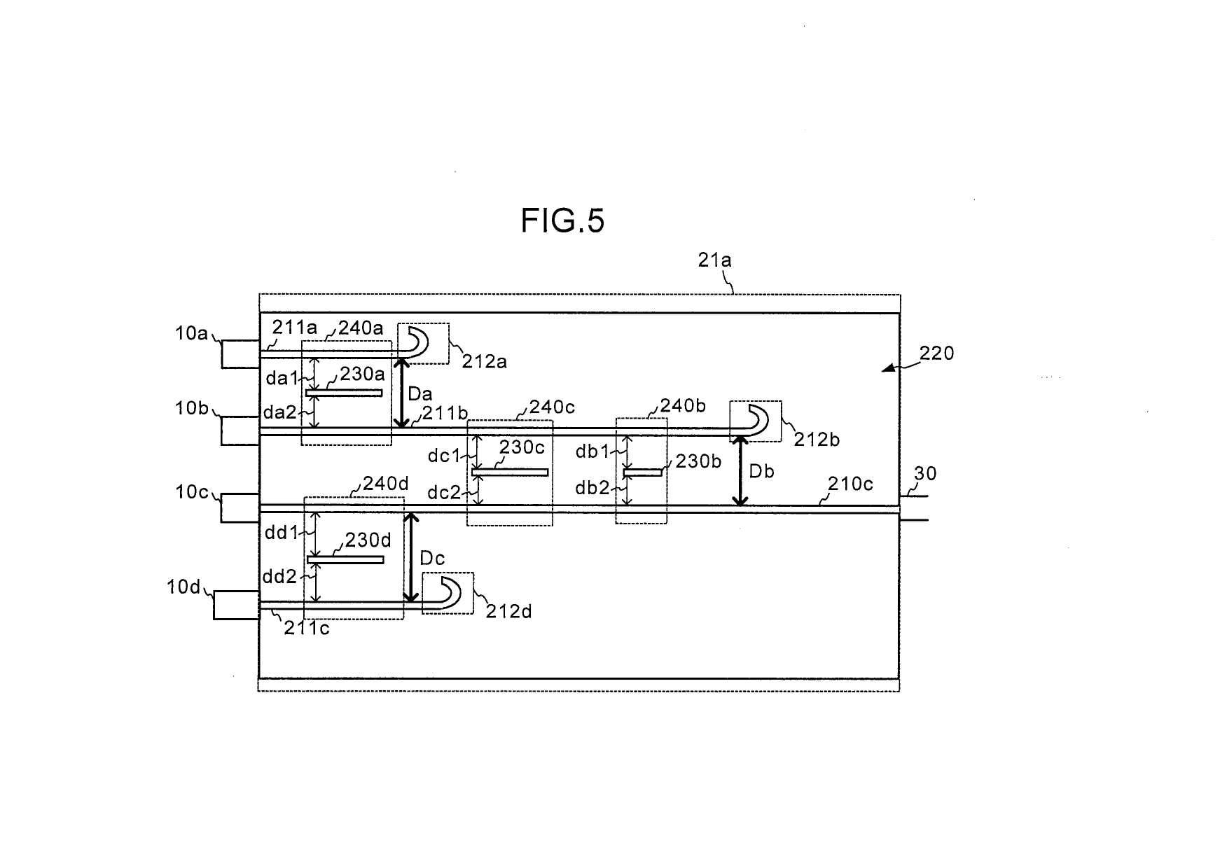

An optical multiplexer 21a according to Embodiment 2 of the present invention will be described hereafter with reference to FIG. 5. The optical multiplexer 21a is characterized in that the input waveguide is a propagation waveguide 211a having an extinction part 212a. This also applies to propagation waveguides 211b and 211c. The optical multiplexer 21a is the same in the other structure as the optical multiplexer 20a according to Embodiment 1.

The extinction part 212a (also extinction parts 212b and 212d) is a bend of the waveguide (waveguide bend or curved portion) formed at the other end (the end on the inner side) of the propagation waveguide 211a. Light having reached this bend is extinguished by the curvature. If some light fails to shift in the transition part 240 and remains in the pre-transition propagation waveguide, this remaining light can be attenuated in the extinction part.

The waveguide bend should have a length and curvature determined by simulation or experiments using an finite element approach based on the equivalent curve approximation or cylindrical coordinate system so that input light supposed from the design is sufficiently extinguished (for example, optical loss of 20 dB or more).

As described above, the optical multiplexer 21a of this embodiment can realize optical multiplexing with excellent optical efficiency.

For example, if the resonance waveguide has a length different from the complete coupling length for a desired wavelength due to manufacturing error, light of the desired transition wavelength may not completely shift in the transition part and remains in the pre-transition propagation waveguide or light that has shifted once may return. In such a case, if the remaining light is reflected and reaches the input terminal, the light emitters 10a and 10b interfere with regard to light from the light emitter 10a (the light emitters 10b and 10c with regard to light from the light emitting part 10b, and the light emitters 10c and 10d with regard to light from the light emitting part 10d), whereby the light emitting efficiency drops. The optical multiplexer device 21a of this embodiment reduces the remaining light by means of the extinction part 212a, preventing the optical efficiency from dropping. In other words, an optical multiplexing/demultiplexing device with excellent optical efficiency can be provided regardless of manufacturing errors.

### Embodiment 3

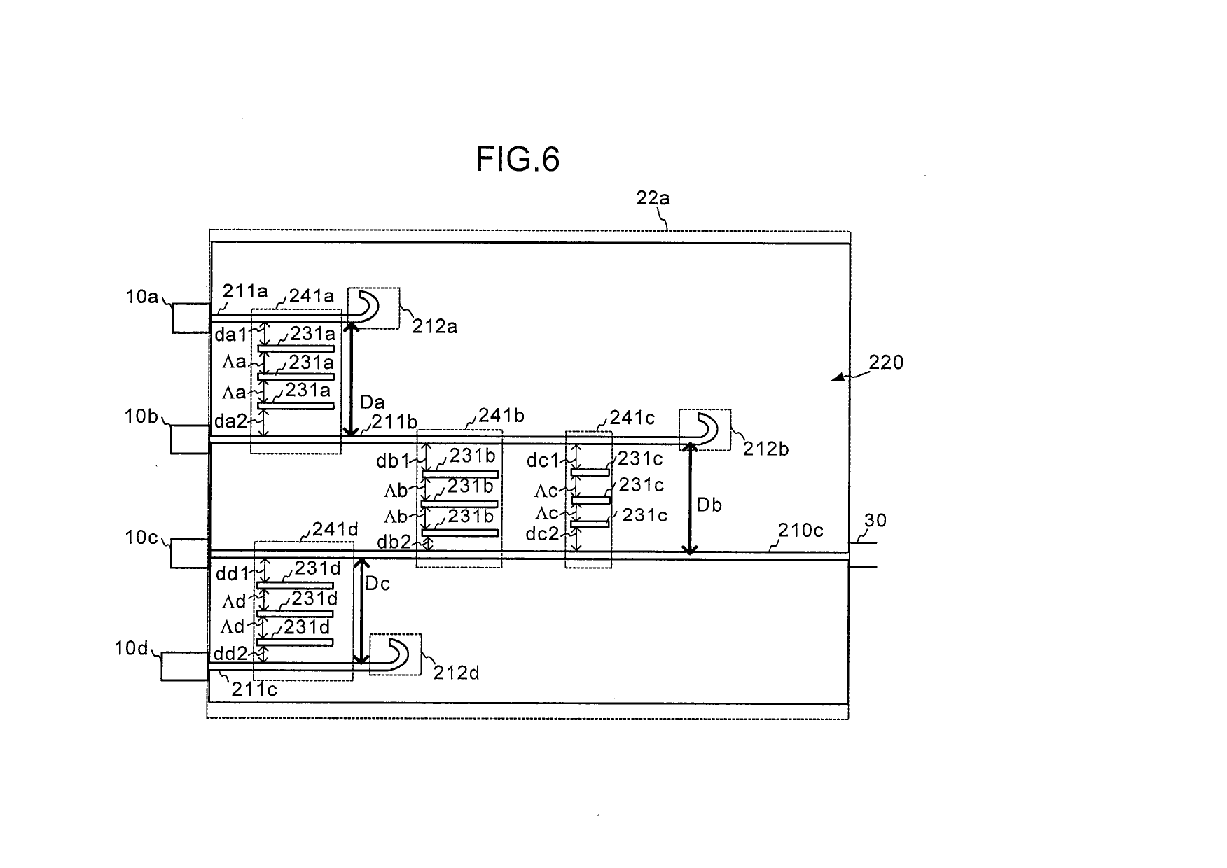

An optical multiplexer 22a according to Embodiment 3 of the present invention will be described hereafter with reference to FIG. 6.

The optical multiplexer 22a is characterized in that a transition part consists of a plurality of resonance waveguides. The optical multiplexer 22a is the same in the other structure as the optical multiplexer 21a according to Embodiment 2.

The transition part of this embodiment will be described hereafter using a transition part 241c by way of example. The same applies to the other transition parts. The transition part 241c includes Nr (here, three) resonance waveguides 231c. The resonance waveguides 231c are provided at intervals Λc. The length, core size, and transmittance of the resonance waveguides are determined by simulation in the same manner as the resonance waveguides according to Embodiments 1 and 2.

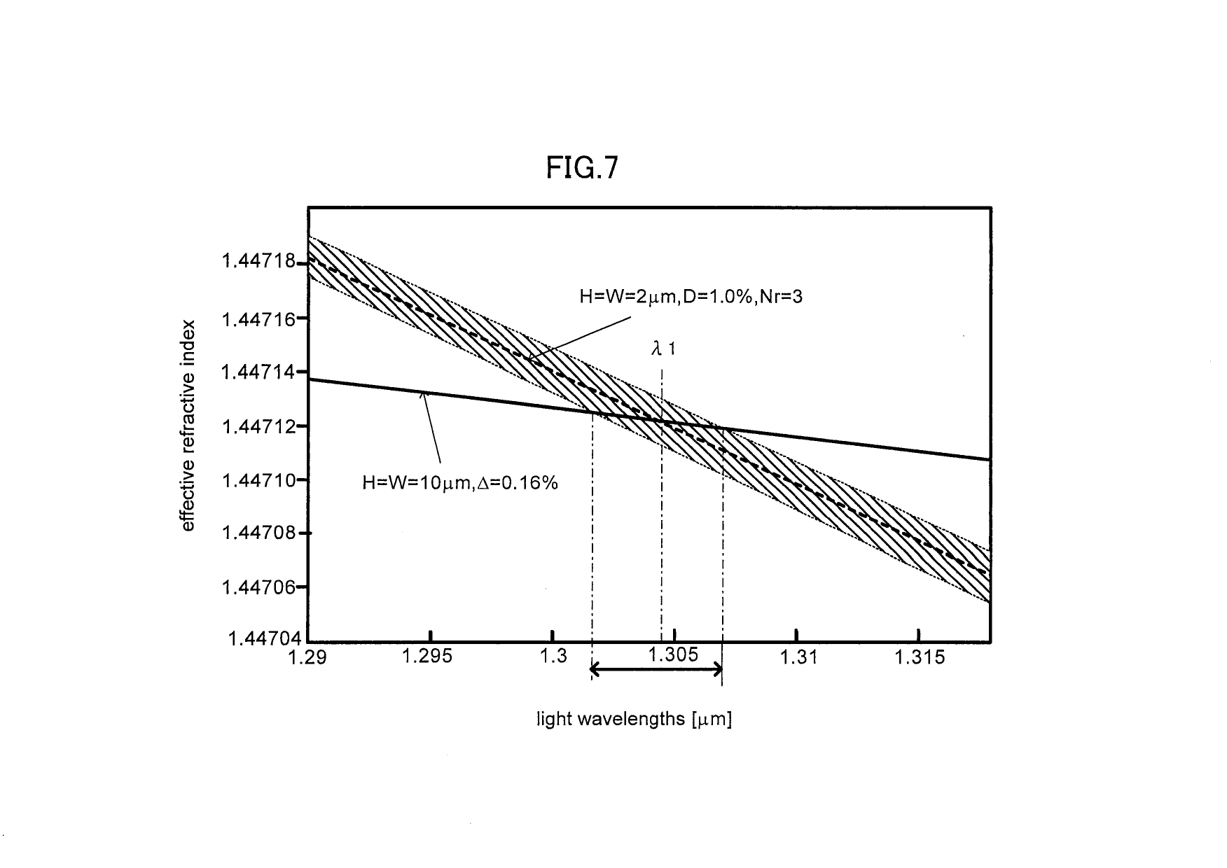

In the transition part 241c, a coupling mode is formed among the plurality of the resonance waveguides 231c. Consequently, the dispersion curve obtained by treating the multiple resonance waveguides 231c as one resonance waveguide consists of a band. FIG. 7 shows an exemplary band of a dispersion curve. The solid line in FIG. 7 presents a dispersion curve when the propagation waveguides 211b and 210c have W=H=10 μm and Δ=0.16%. On the other hand, the multiple resonance waveguides 231c having W=H=2 μm and Δ=1% can be considered to collectively have a band of a dispersion curve in the shaded area.

Consequently, the transition wavelength of the transition part 241c is expanded to a domain (a transition band, the width of the arrow of FIG. 7) around the transition wavelength λ1 of the transition part 241c. In other words, when light of a range of wavelengths included in the wavelength band presented by the bold arrow in FIG. 7 passes through either one of the propagation waveguides (adjoining waveguides) constituting the transition part 241c (the propagation waveguide 211b or propagation waveguide 210c), the light of that range of wavelength components shifts to the other propagation waveguide.

As Λc is decreased, the coupling factor between the resonance waveguides is increased; then, the transition band's width is increased. Conversely, as Λc is increased, the coupling factor between the resonance waveguides is diminished; then, the transition band's width is reduced.

The transition band's width can be obtained by simulation using the Maxwell's equations based on the intervals Λc. And complete coupling length can be obtained by simulation using the Maxwell's based on the distances dc1 and dc2, in which dc1 and dc2 are the distances between the propagation waveguides and the resonance waveguides adjoin to the propagation waveguides. In other words, the intervals Λc to yield a desired band's width and the distances dc1 and dc2 to yield a desired complete coupling length are calculated by the simulation and the transition part 241a is designed according to the calculation results.

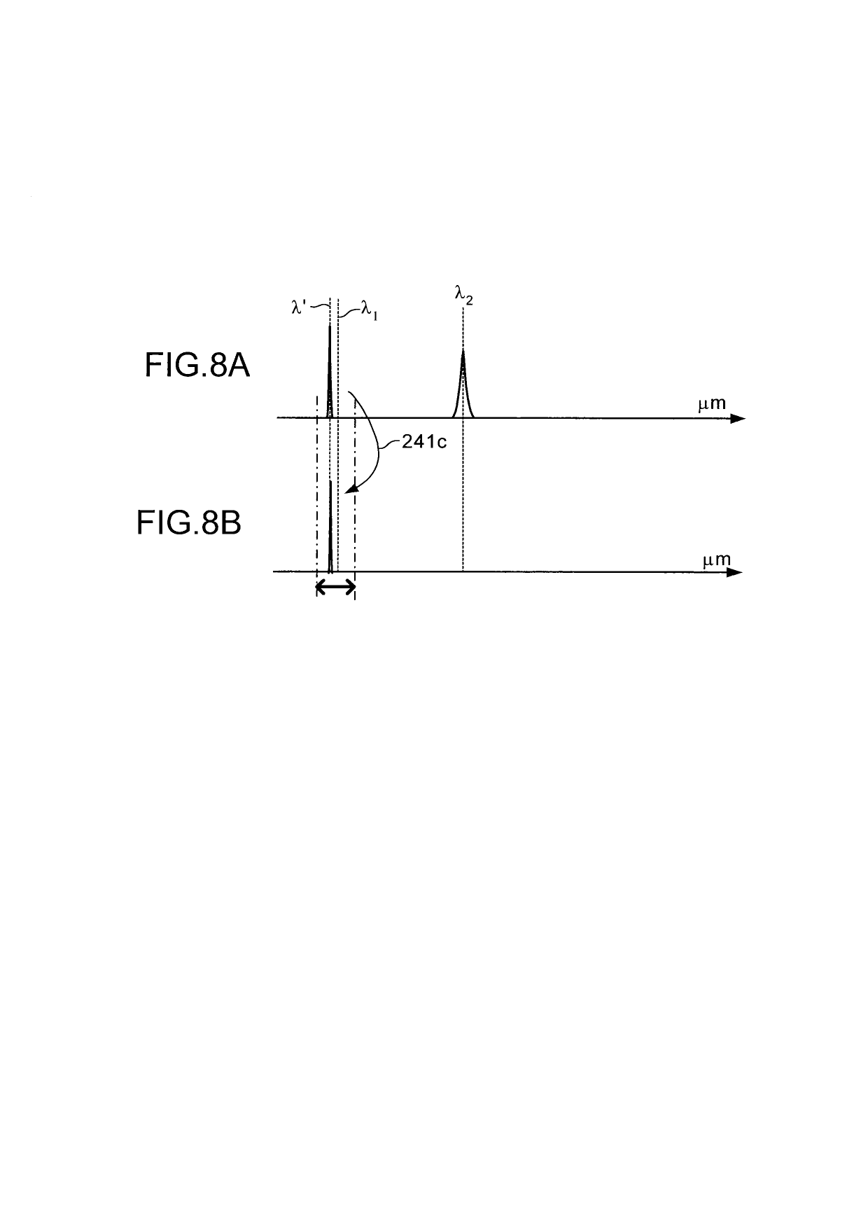

In this embodiment, the dimension of Λc is adjusted so that the transition band is set to a supposable range of errors of λ1 (a narrow band). The narrow band will be discussed with reference to FIGS. 8A and 8B. FIG. 8A shows a wavelength spectrum of light passing through the pre-transition propagation waveguide (the propagation waveguide 211b) of the propagation waveguides constituting the transition part 241c. FIG. 8B shows a wavelength spectrum of light in the post-transition propagation waveguide (the propagation waveguide 210c). Here, the wavelength of light is plotted as abscissa and the intensity of light of a corresponding wavelength is plotted as ordinate.

In FIG. 8, the light to be shifted has a peak shifted from λ1 to λ′ due to manufacturing error. However, the λ′ is included in the narrow band presented by the bold arrow. Therefore, the light can be shifted in the transition part 241c. In other words, use of a narrow band as the transition band results in expanding the transition wavelength of the transition part 241c over a supposable range of fluctuation of peak (manufacturing error of the light emitter and/or fluctuation of the transition wavelength of the upstream transition part) around the transition wavelength (λ1) assigned to the transition part 241c.

Here, the narrow band refers to a range of light supposed from the design to pass through the transition part 241c excluding the wavelengths of light of which the source (the light emitter that is the emission source) is different from the one for the wavelength having a peak at λ1 (for example, light having a peak at λ2 in FIG. 7). The narrow band is set by measuring λ1, the range of λ′, and the difference between λ2 and λ1 in experiments, and determining Λc and Nr.

As described above, the optical multiplexer 22a of this embodiment utilizes a flat top transition wavelength and is therefore highly reliable. In other words, this embodiment can provide an optical multiplexing/demultiplexing device with high manufacturing tolerance.

Here, the explanation is made using the structure of the optical multiplexer 22a connected to the light emitters 10a to 10d by way of example. In this embodiment, an optical demultiplexer connected to the light receptors 40a to 40d has the same structure. The optical demultiplexer of this embodiment is highly reliable as the multiplexer 22a.

### Embodiment 4

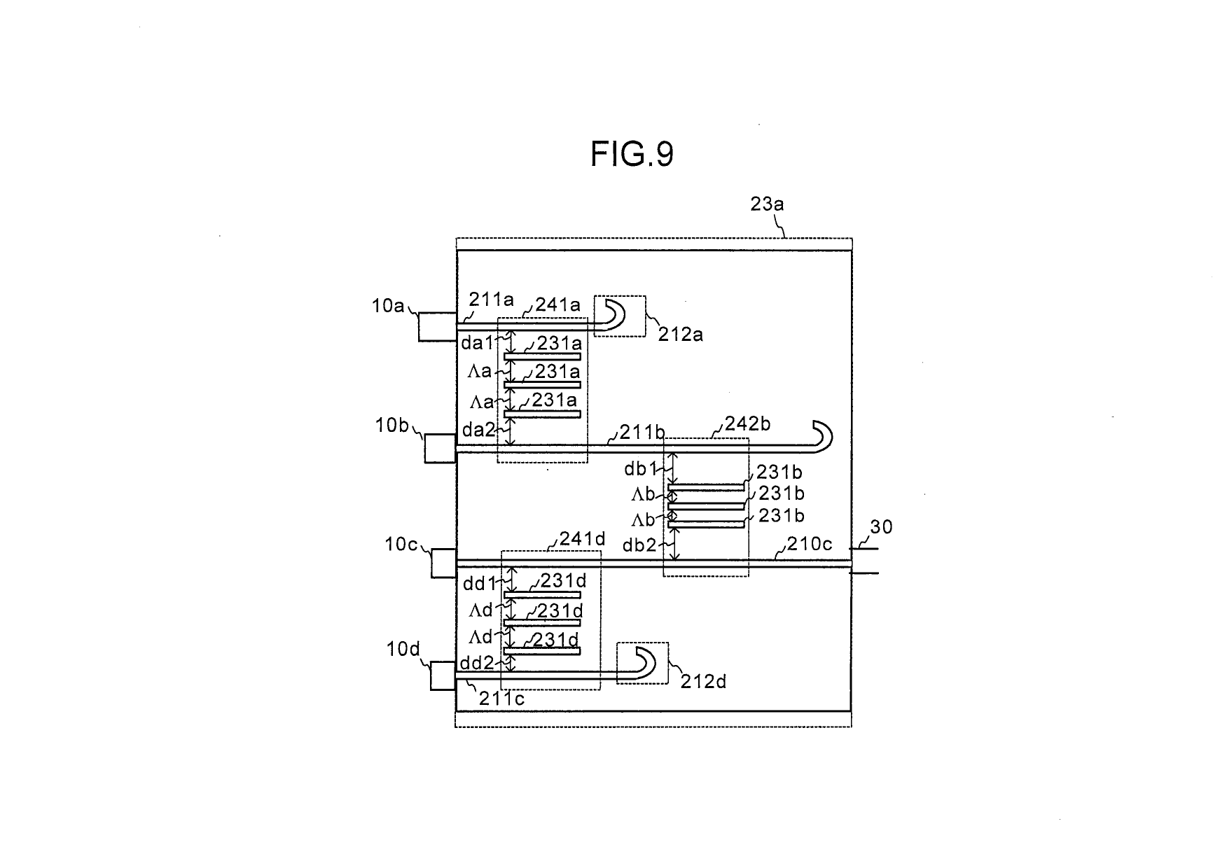

An optical multiplexer 23a according to Embodiment 4 of this embodiment will be described with reference to FIG. 9.

The optical multiplexer 23a of this embodiment is different from the optical multiplexer 22a according to Embodiment 3 in the setting of the transition part. The optical multiplexer 23a is the same in the other structure as the optical multiplexer 22a according to Embodiment 3.

The optical multiplexer 23a of this embodiment is characterized by including a transition part 242b in which the transition band is set to a wide band. The transition part 242b includes Nr (three) resonance waveguides 231b as in the transition part of a narrow band. The resonance waveguides 231b are provided at intervals Λb.

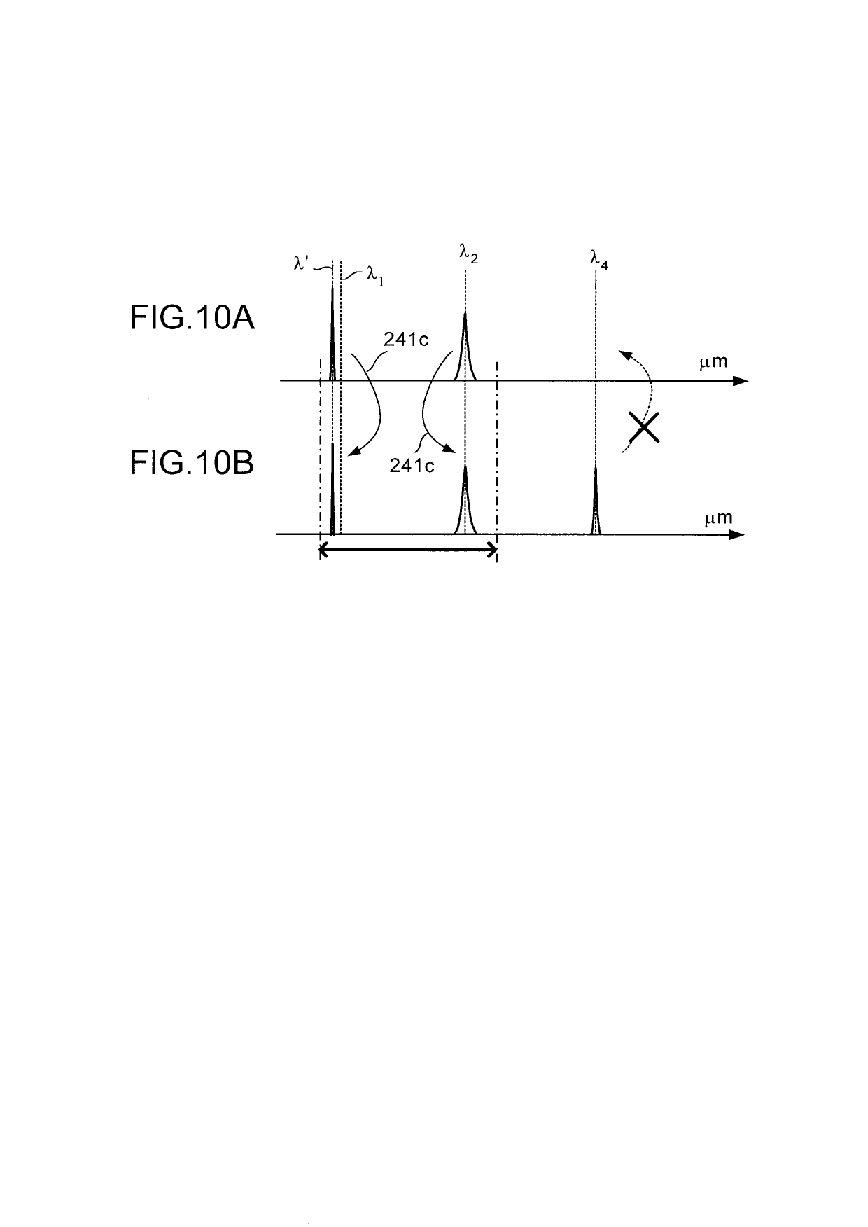

The wide band of this embodiment will be discussed with reference to FIGS. 10A and 10B.

FIG. 10A shows a wavelength spectrum of light passing through the pre-transition propagation waveguide (the propagation waveguide 211b) of the propagation waveguides constituting the transition part 242b. FIG. 10B shows a wavelength spectrum of light in the post-transition propagation waveguide (the propagation waveguide 210c). Here, the wavelength of light is plotted as abscissa and the intensity of light of a corresponding wavelength is plotted as ordinate.

The transition band (a wide band, the bold arrow in FIG. 10B) of the transition part 242b includes both light having a peak at λ′ of which the source is the light emitter 10a and light having a peak at λ2 of which the source is the light emitter 10b. Therefore, the transition part 242b is provided with the functions of both the transition parts 241b and 241c in Embodiment 3. In other words, one transition part can shift light having a peak at a wavelength λ (or λ′) and light having a peak at a wavelength λ2.

However, for preventing backward traveling from the post-transition waveguide (the propagation waveguide 210c), the transition band is designed not to include the wavelength of light passing by the transition part 242b in the post-transition propagation waveguide (light having a peak at λ4 in FIG. 10B).

Here, the transition band width can be obtained by simulation using the Maxwell's equations based on the core shape, refractive index, and intervals Λb of the propagation waveguides and resonance waveguides as in Embodiment 3. More specifically, for obtaining a transition bandwidth of 5.1 nm, the following structure can be used. It is assumed that the propagation waveguides have W=H=10 μm and Δ=0.16% and the resonance waveguides 231a have W=H=2 μm and Δ=1% in which W and H are the horizontal length and vertical length of a waveguide core and Δ is the relative refractive index difference between the core and clad. In such a case, if the number of resonance waveguides is Nr=3 and the resonance waveguide intervals are Λ=20 μm, a transition bandwidth of 5.1 nm is obtained for a transition center wavelength of 1.304 μm.

This embodiment can shift light having two peaks with one transition part, thereby reducing the longitudinal length of the optical multiplexer 23a. Here, the explanation is made using the structure of the optical multiplexer 23a connected to the light emitters 10a to 10d by way of example. In this embodiment, an optical demultiplexer connected to the light receptors 40a to 40d has the same structure. In other words, a reduced-in-size optical multiplexing/demultiplexing device can be provided.

The present invention is suitable for, for example, optical communication systems.

Having described and illustrated the principles of this application by reference to one or more preferred embodiments, it should be apparent that the preferred embodiments may be modified in arrangement and detail without departing from the principles disclosed herein and that it is intended that the application be construed as including all such modifications and dispersions insofar as they come within the spirit and scope of the subject matter disclosed herein.

### LEGEND

1 Optical transfer system
10a to 10d Light emitter
20a Optical multiplexer
20b Optical demultiplexer
21a Optical multiplexer
22a Optical multiplexer
23a Optical multiplexer
30 Optical cable
41a to 40d Light receptor
210a to 210d Propagation waveguide
211a, 211b, 211c Propagation waveguide
212a, 212b, 212d Extinction part
220 Clad
230a to 230d Resonance waveguide
231a to 231d Resonance waveguide
240a to 240d Transition part
241a to 241d Transition part
242b Transition part

What is claimed is:

1. An optical multiplexing/demultiplexing device, comprising:
a plurality of propagation waveguides that is optical waveguides propagating light and comprising an input waveguide capable of receiving input light and an output waveguide outputting light of a given wavelength among the wavelengths included in the input light; and
a resonance waveguide that is an optical waveguide provided between adjoining waveguides and extends in a longitudinal direction in which both the adjoining waveguides extend, wherein the adjoining waveguides are an adjoining pair among the plurality of the propagation waveguides,
wherein the distance between the resonance waveguide and each of the adjoining waveguides of the resonance waveguide and a length in the longitudinal direction of the resonance waveguide are set so as to form a transition part, wherein when a light comprising a transition wavelength set to the transition part passes through the transition part of one of the adjoining waveguides, the light of the transition wavelength component shifts to the other adjoining propagation waveguide.

2. The optical multiplexing/demultiplexing device according to claim 1, wherein:
the resonance waveguide and the adjoining waveguides of the resonance waveguide have a substantially equally effective refractive index for light of the transition wavelength of the transition part formed by the resonance waveguide.

3. The optical multiplexing/demultiplexing device according to claim 1, wherein:
the plurality of the propagation waveguides comprises a plurality of the input waveguides; and
each of the plurality of the input waveguides is connected to a light emitter emitting light of particular wavelengths.

4. The optical multiplexing/demultiplexing device according to claim 3, wherein:
the input waveguide has an input end connected to a light emitter emitting light of a given wavelength and an other end; and
the other end of the input waveguide forms a curved portion.

5. The optical multiplexing/demultiplexing device according to claim 1, wherein:
the input waveguide receive light of a plurality of given wavelengths;
the plurality of the propagation waveguides comprises a plurality of the output waveguides; and
each of the plurality of the output waveguides is connected to an optical sensing part sensing light of one of the plurality of the given wavelengths.

6. The optical multiplexing/demultiplexing device according to claim 1, wherein:
the plurality of the propagation waveguides and the resonance waveguide extend in a common longitudinal direction; and
a combination of the resonance waveguide and the adjoining propagations forming the transition part is provided in a multistage manner in a circumferential direction with respect to the longitudinal direction.

7. The optical multiplexing/demultiplexing device according to claim 1, wherein:
the transition part comprises a plurality of the resonance waveguides of a given length determined according to the transition wavelength set for the transition part; and
the plurality of the resonance waveguides of the transition part is provided at intervals that expand the transition wavelength of the transition part to a band of a given width over which the wavelength of the light to be shifted in the transition part supposedly fluctuates.

8. The optical multiplexing/demultiplexing device according to claim 1, wherein:
the transition part comprises a plurality of the resonance waveguides of the given length determined according the transition wavelength set for the transition part; and
the plurality of the resonance waveguides of the transition part is provided at intervals that expand the transition wavelength of the transition part to a band, wherein the band comprises a plurality of a given wavelength peaks of light passing through the adjoining waveguide far from the output waveguide and excludes a wavelength peak of light passing through the adjoining waveguide closer to the output waveguide.
